(19) United States
(12) Patent Application Publication
(10) Pub. No.: US 2026/0185549 A1
(43) Pub. Date: Jul. 2, 2026

(54) FLUID PRESSURE CYLINDER

(71) Applicant: KYB Corporation, Tokyo (JP)

(72) Inventor: Natsuki TANIGAWA, Tokyo (JP)

(73) Assignee: KYB Corporation, Tokyo (JP)

(21) Appl. No.: 18/846,960

(22) PCT Filed: Feb. 27, 2023
(86) PCT No.: PCT/JP2023/007149

§ 371 Date: Sep. 13, 2024

(30) Foreign Application Priority Data
Mar. 18, 2022 (JP) 2022-044047

(51) Int. Cl. F15B 15/14

(52) U.S. Cl. CPC F15B 15/16; F15B 15/149; F15B 2211/7057

(57) ABSTRACT

A hydraulic cylinder includes: a rod member; and a rod head, the rod member has: a first rod inner passage being configured to guide a hydraulic fluid to one of a rod side chamber and a counter rod side chamber; and a annular second rod inner passage being configured to guide the hydraulic fluid to the other of the rod side chamber and the counter rod side chamber, the rod head has: a first passage through which the outside of the rod head and the first rod inner passage are communicated; and a second passage through which the outside of the rod head and the second rod inner passage are communicated, and the second passage has: a main passage opening at an outer surface of the rod head; and a plurality of branch passages provided by being branched from the main passage, the branch passages each communicating with the second rod inner passage.

### TECHNICAL FIELD

The present invention relates to a fluid pressure cylinder.

### BACKGROUND ART

JP2021-143704A discloses a fluid pressure cylinder including: a cylinder tube; a piston unit that is slidably inserted into the cylinder tube and that defines a rod side chamber and a counter rod side chamber in the cylinder tube; a rod member that is inserted into the cylinder tube; and a tube member that is provided in the rod member and that guides hydraulic fluid to the counter rod side chamber. A hollow part is formed inside the rod member, and the hollow part is communicated with the rod side chamber. In addition, the rod member has an attachment portion for attaching the fluid pressure cylinder to a driving target, and two flow paths provided in the attachment portion that respectively communicate with the tube member and the hollow part.

### SUMMARY OF INVENTION

With the fluid pressure cylinder disclosed in JP2021-143704A, because the two flow paths are provided in the attachment portion, there is a problem in that it is difficult to ensure a flow path cross-sectional area, and a significant pressure loss is caused in the two flow paths. If the cross-sectional areas of the two flow paths are increased by increasing the size of the attachment portion, the size of the fluid pressure cylinder becomes larger.

An object of the present invention is to reduce a pressure loss without increasing the size of a fluid pressure cylinder.

According to one aspect of the present invention, A fluid pressure cylinder includes: a cylinder tube; a piston unit slidably inserted into the cylinder tube, the piston unit being configured to define a rod side chamber and a counter rod side chamber inside the cylinder tube; a rod member inserted into the cylinder tube, a first end of the rod member being connected to the piston unit; and a rod head provided on a second end of the rod member, the rod member has: a first rod inner passage provided inside the rod member, the first rod inner passage being configured to guide hydraulic fluid to one of the rod side chamber and the counter rod side chamber; and an annular second rod inner passage provided inside the rod member so as to surround the first rod inner passage, the second rod inner passage being configured to guide hydraulic fluid to other of the rod side chamber and the counter rod side chamber, the rod head has: a first passage through which outside of the rod head and the first rod inner passage are communicated; and a second passage through which the outside of the rod head and the second rod inner passage are communicated, and the second passage has: a main passage opening at an outer surface of the rod head; and a plurality of branch passages provided by being branched from the main passage, the branch passages each communicating with the second rod inner passage.

### BRIEF DESCRIPTION OF DRAWINGS

FIG. 1 is a schematic view of a cross-section of a hydraulic cylinder according to an embodiment of the present invention, and is a diagram showing a most-contracted state.

FIG. 2 is a plan view showing, in enlargement, a rod head.

FIG. 3 is a perspective view showing, in enlargement, the rod head.

FIG. 4 is an enlarged view of the rod head, viewed from the A direction in FIG. 3.

FIG. 5 is a schematic view of a cross-section of the hydraulic cylinder according to the embodiment of the present invention, and is a diagram showing a state in which a first piston is positioned at an extended position, and a second piston and a third piston are positioned at a contracted position.

FIG. 6 is a schematic view of a cross-section of the hydraulic cylinder according to the embodiment of the present invention, and is a diagram showing a state in which the first piston and the second piston are positioned at the extended position, and the third piston is positioned at the contracted position.

FIG. 7 is a schematic view of a cross-section of the hydraulic cylinder according to the embodiment of the present invention, and is a diagram showing a most-extended state.

FIG. 8 is a schematic view of a cross-section of the rod head according to a second modification of the embodiment of the present invention.

FIG. 9 is a schematic view of a cross-section of the rod head according to a third modification of the embodiment of the present invention.

FIG. 10 is an enlarged sectional view of a projecting portion of the rod head according to a fourth modification of the embodiment of the present invention.

### DESCRIPTION OF EMBODIMENTS

Embodiments of the present invention will be described below with reference to the drawings.

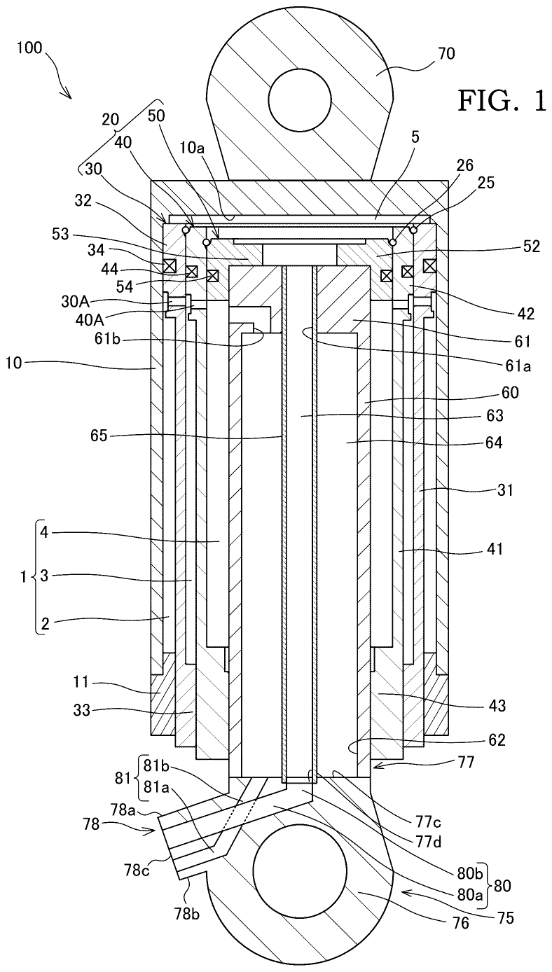

A multistage fluid pressure cylinder 100 according to an embodiment of the present invention will be described with reference to FIGS. 1 to 4. In the following, a description will be given of a case in which the multistage fluid pressure cylinder 100 is the multistage hydraulic cylinder 100 (hereinafter, simply referred to as “the hydraulic cylinder 100”) that is driven by employing working oil as hydraulic fluid.

The hydraulic cylinder 100 is attached to a target object and drives the target object by being extended and contracted. For example, the hydraulic cylinder 100 is a hoist cylinder that is attached between a cargo bed of a dump truck and a vehicle body to moves the cargo bed up and down. As the hydraulic cylinder 100 is extended, the cargo bed is tilted, and the loaded material on the cargo bed is discharged.

As shown in FIG. 1, the hydraulic cylinder 100 includes: a cylinder tube 10 having a bottomed barrel shape; a piston unit 20 that is slidably inserted into the cylinder tube 10 and that defines a rod side chamber 1 and a counter rod side chamber 5 inside the cylinder tube 10; a rod member 60 that is inserted into the cylinder tube 10 and a first end thereof is connected to the piston unit 20; a cylinder-side attachment portion 70 that is provided on a bottom portion of the cylinder tube 10; and a rod head 75 serving as a rod-side attachment portion that is provided on a second end of the rod member 60. FIG. 1 is a schematic view of a cross-section of the hydraulic cylinder 100 in a most-contracted state.

The hydraulic cylinder 100 is attached to the target object via the cylinder-side attachment portion 70 and the rod head 75 such that the cylinder tube 10 is positioned on the vertically upper side and the rod member 60 is positioned on the vertically lower side. In addition, the hydraulic cylinder 100 is attached to the target object such that the cylinder-side attachment portion 70 is displaced relative to the rod head 75 substantially in the vertical direction, in other words, in the up and down direction. The orientation in which the hydraulic cylinder 100 is attached is not limited to this configuration, and the hydraulic cylinder 100 may be attached such that the cylinder tube 10 is positioned on the vertically lower side and the rod member 60 is positioned on the vertically upper side. In addition, the hydraulic cylinder 100 may be attached to the target object so as to be extended/contracted in the horizontal direction.

The piston unit 20 has: a first piston 30 that slides on an inner circumferential surface of the cylinder tube 10; a second piston 40 that slides on an inner circumferential surface of the first piston 30; a third piston 50 that slides on an inner circumferential surface of the second piston 40 and to which the rod member 60 is connected. A cylinder head 11 that slidably supports the first piston 30 of the piston unit 20 is provided on an opening portion of the cylinder tube 10.

The rod side chamber 1 has a first rod side chamber 2, a second rod side chamber 3, and a third rod side chamber 4. The first rod side chamber 2 is defined by the cylinder tube 10, the cylinder head 11, and the first piston 30. The second rod side chamber 3 is defined by the first piston 30 and the second piston 40. The third rod side chamber 4 is defined by the second piston 40, the third piston 50, and the rod member 60.

The counter rod side chamber 5 is defined by the cylinder tube 10, the piston unit 20, and the rod member 60. As described above, the rod side chamber 1 and the counter rod side chamber 5 are defined within the cylinder tube 10.

On an inner circumferential surface of the cylinder head 11, a seal member (not shown) for sealing a gap between the inner circumferential surface of the cylinder head 11 and an outer circumferential surface of the first piston 30 is provided.

The bottom portion of the cylinder tube 10 is formed with a recessed portion 10a that opens to the counter rod side chamber 5. An inner diameter of the recessed portion 10a is set so as to be larger than an inner diameter of the first piston 30. With such a configuration, the pressure of the working oil guided to the recessed portion 10a acts on the first piston 30.

The first piston 30 has: a first main body portion 31 having a barrel shape; a cylindrical first sliding contact portion 32 that is formed so as to project radially outward from the one end portion of the first main body portion 31 and that comes into sliding contact with the inner circumferential surface of the cylinder tube 10; a cylindrical first support portion 33 that is formed so as to project radially inward from the other end portion of the first main body portion 31 to slidably support the second piston 40; and a first piston ring 34 that is provided on an outer circumferential surface of the first sliding contact portion 32.

In the first main body portion 31, a first communication port 30A that penetrates through the first main body portion 31 in the radial direction is formed at the position adjacent to the first sliding contact portion 32. The first rod side chamber 2 communicates with the second rod side chamber 3 via the first communication port 30A in a state in which the second piston 40 is positioned at a most-contracted position.

The first sliding contact portion 32 slides between the bottom portion of the cylinder tube 10 and the cylinder head 11. With the first piston 30, the most-contracted position is defined as the first sliding contact portion 32 comes into contact with the bottom portion of the cylinder tube 10, and a most-extended position is defined as the first sliding contact portion 32 comes into contact with the cylinder head 11.

On an inner circumferential surface of the first support portion 33, a seal member (not shown) for sealing a gap between the inner circumferential surface of the first support portion 33 and an outer circumferential surface of the second piston 40 is provided.

The first piston ring 34 is an annular member. By providing the first piston ring 34, the communication between the first rod side chamber 2 and the counter rod side chamber 5 through a gap between the outer circumferential surface of the first sliding contact portion 32 and the inner circumferential surface of the cylinder tube 10 is shut off.

In addition, a bush (not shown) that comes into sliding contact with the inner circumferential surface of the cylinder tube 10 is provided on the outer circumferential surface of the first sliding contact portion 32. As the bush comes into sliding contact with the inner circumferential surface of the cylinder tube 10, the first piston 30 is slidably supported by the cylinder tube 10.

A first snap ring 25 that can engage with the second piston 40 is installed in an annular groove formed in an inner circumferential surface of the first main body portion 31. The first snap ring 25 restricts detachment of the first piston 30 from the second piston 40.

The second piston 40 has a similar configuration to the first piston 30. Specifically, as shown in FIG. 1, the second piston 40 has: a second main body portion 41 having a barrel shape; a cylindrical second sliding contact portion 42 that is formed so as to project radially outward from the one end portion of the second main body portion 41 and that comes into sliding contact with the inner circumferential surface of the first piston 30; a cylindrical second support portion 43 that is formed so as to project radially inward from the other end portion of the second main body portion 41 to slidably support the rod member 60; and a second piston ring 44 that is provided on an circumferential surface of the second sliding contact portion 42.

In the second main body portion 41, a second communication port 40A that penetrates through the second main body portion 41 in the radial direction is formed at the position adjacent to the second sliding contact portion 42. The second rod side chamber 3 communicates with the third rod side chamber 4 via the second communication port 40A in a state in which the third piston 50 is positioned at the most-contracted position.

The second sliding contact portion 42 slides between the first snap ring 25 of the first piston 30 and the first support portion 33. With the second piston 40, the most-contracted position is defined as the second sliding contact portion 42 comes into contact with the first snap ring 25, and the most-extended position is defined as the second sliding contact portion 42 comes into contact with the first support portion 33.

On inner circumferential surface of the second support portion 43, the seal member (not shown) for sealing a gap between the inner circumferential surface of the second support portion 43 and an outer circumferential surface of the rod member 60 is provided.

The second piston ring 44 is an annular member similarly to the first piston ring 34. By providing the second piston ring 44, the communication between the second rod side chamber 3 and the counter rod side chamber 5 through a gap between the outer circumferential surface of the second sliding contact portion 42 of the second piston 40 and the inner circumferential surface of the first main body portion 31 of the first piston 30 is shut off.

The bush (not shown) that comes into sliding contact with the inner circumferential surface of the first piston 30 is provided on the outer circumferential surface of the second sliding contact portion 42. As the bush comes into sliding contact with the inner circumferential surface of the first piston 30, the second piston 40 is slidably supported by the first piston 30.

A second snap ring 26 that can engage with the third piston 50 is installed in an annular groove formed in an inner circumferential surface of the second main body portion 41. The second snap ring 26 restricts detachment of the second piston 40 from the third piston 50.

The third piston 50 has a third sliding contact portion 52 that comes into sliding contact with the inner circumferential surface of the second piston 40 and a third piston ring 54 that is provided on an outer circumferential surface of the third sliding contact portion 52. An annular flange portion 53 is formed on an inner circumferential surface of the third sliding contact portion 52, and the flange portion 53 is connected to a tip end portion of the rod member 60 via a plurality of bolts.

The third sliding contact portion 52 slides between the second snap ring 26 of the second piston 40 and the second support portion 43. With the third piston 50, the most-contracted position is defined as the third sliding contact portion 52 comes into contact with the second snap ring 26, and the most-extended position is defined as the third sliding contact portion 52 comes into contact with the second support portion 43.

The third piston ring 54 is an annular member similarly to the first and second piston rings 34 and 44. By providing the third piston ring 54, the communication between the third rod side chamber 4 and the counter rod side chamber 5 through a gap between the outer circumferential surface of the third sliding contact portion 52 of the third piston 50 and the inner circumferential surface of the second main body portion 41 of the second piston 40 is shut off.

In addition, the bush (not shown) that comes into sliding contact with the inner circumferential surface of the second piston 40 is provided on the outer circumferential surface of the third sliding contact portion 52. As the bush comes into sliding contact with the inner circumferential surface of the second piston 40, the third piston 50 is slidably supported by the second piston 40.

As shown in FIG. 1, the rod member 60 is formed to have a bottomed cylindrical shape, the third sliding contact portion 52 of the third piston 50 is connected to a bottom portion 61, and the rod head 75 is connected to an opening portion 62. The rod member 60 moves within the cylinder tube 10 in the the axial direction together with the third piston 50.

A pipe-shaped pipe 65 is provided in a hollow part in the rod member 60 so as to extend in the axial direction of the rod member 60. A first end of the pipe 65 opens at the counter rod side chamber 5, and a second end of the pipe 65 opens at the rod head 75. Specifically, the first end of the pipe 65 is inserted into a first through hole 61a that penetrates through the center of the bottom portion 61 of the rod member 60 in the axial direction, and the first end is fixed to the first through hole 61a by press-fitting, welding, or the like. In other words, the first end of the pipe 65 is provided such that its center coincides with the center axis O of the rod member 60. In addition, a second end of the pipe 65 is inserted into the rod head 75 (a pipe attachment hole 77d, which will be described later) and is fixed in the rod head 75 by press-fitting, welding, or the like. A first rod inner passage 63 is formed inside the pipe 65. The working oil is supplied to and discharged from the counter rod side chamber 5 through the first rod inner passage 63.

Within the rod member 60, a second rod inner passage 64 is formed on the outer side of the pipe 65. Specifically, the second rod inner passage 64 is formed so as to have an annual shape between an inner circumferential surface of the rod member 60 and an outer circumferential surface of the pipe 65. The second rod inner passage 64 communicates with the third rod side chamber 4 through a second through hole 61b that is formed in the bottom portion 61 of the rod member 60. The working oil is supplied to and discharged from the rod side chamber 1 through the second rod inner passage 64.

As described above, the rod member 60 has: the first rod inner passage 63 that is provided in the rod member 60 and that guides the working oil to the counter rod side chamber 5; and the annular second rod inner passage 64 that is provided in the rod member 60 so as to surround the first rod inner passage 63 and that guides the working oil to the rod side chamber 1.

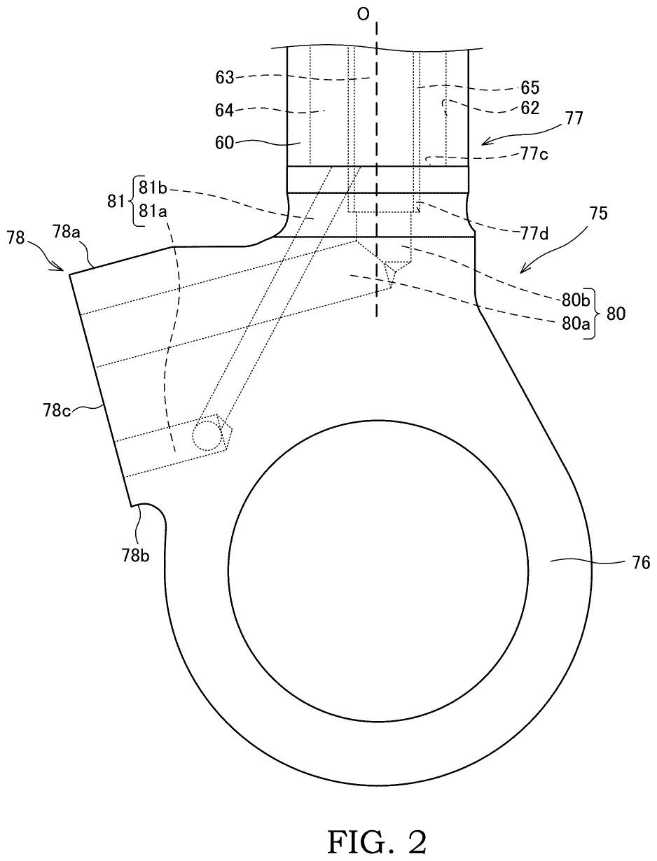

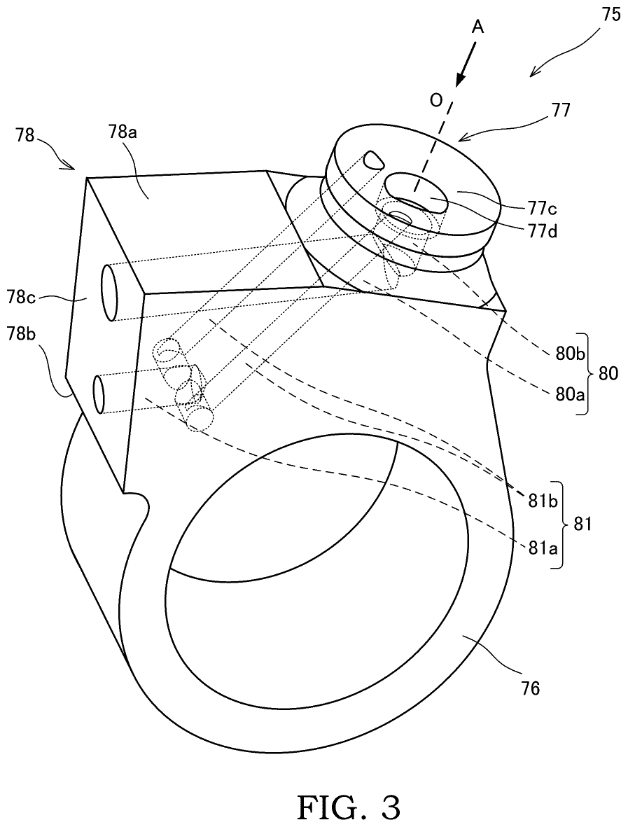

As shown in FIGS. 2 and 3, the rod head 75 has: a cylindrical attachment portion 76 that is attached to an attachment target; a connecting portion 77 that is connected to the rod member 60; and a projecting portion 78 that projects out from an outer surface of the attachment portion 76.

The attachment portion 76 forms a main body of the rod head 75. The connecting portion 77 is provided so as to be continuous with the attachment portion 76. The connecting portion 77 is provided so as to open at an end surface 77c and has the pipe attachment hole 77d to which an end portion of the pipe 65 is inserted and attached. The end surface 77c is abutted against an end surface of the opening portion 62 of the rod member 60 and is connected thereto by welding or the like. The inner diameter of the pipe attachment hole 77d is formed to be substantially the same as the outer diameter of the pipe 65. The end portion of the pipe 65 is inserted into the pipe attachment hole 77d and is attached thereto by press-fitting, welding, or the like.

The projecting portion 78 is provided such that the one side surface is continuous with the outer circumferential surface of the rod member 60 and the other side surface is continuous with an outer circumferential surface of the attachment portion 76. Specifically, the projecting portion 78 has: a rod-side inclined side surface 78a that is formed so as to be continuous with the outer circumferential surface of the rod member 60 via the connecting portion 77 and so as to be inclined relative to the attachment portion 76; and a rod-head-side inclined side surface 78b that is formed so as to be continuous with the outer circumferential surface of the attachment portion 76 and so as to be inclined relative to the attachment portion 76. The rod-side inclined side surface 78a and the rod-head-side inclined side surface 78b are formed so as to be parallel with each other. In a cross section including the center axis O of the rod member 60 and parallel to the attachment portion 76 (the cross section shown in FIG. 1), the projecting portion 78 projects by being inclined such that the angle formed by the rod-side inclined side surface 78a and the outer circumferential surface of the rod member 60 becomes an obtuse angle.

The rod head 75 has a first passage 80 through which the outside of the rod head 75 and the first rod inner passage 63 are communicated and a second passage 81 through which the outside of the rod head 75 and the second rod inner passage 64 are communicated. A pump (not shown) or tank (not shown) that are each provided outside is selectively connected to the counter rod side chamber 5 via the first passage 80 and the first rod inner passage 63, and thereby, the working oil is supplied to and discharged from the counter rod side chamber 5. The pump or tank that are each provided outside is selectively connected to the rod side chamber 1 via the second passage 81 and the second rod inner passage 64, and thereby, the working oil is supplied to and discharged from the rod side chamber 1.

The first passage 80 opens at a tip end surface 78c of the projecting portion 78 in the projecting direction and at the pipe attachment hole 77d of the connecting portion 77. The first passage 80 has a passage 80a that extend linearly from the tip end surface 78c of the projecting portion 78 and a passage 80b that extends in the axial direction from the pipe attachment hole 77d and that communicates with the passage 80a. The passage 80b is provided concentrically with the pipe attachment hole 77d. The first passage 80 is provided so as to have a uniform flow path cross-sectional area.

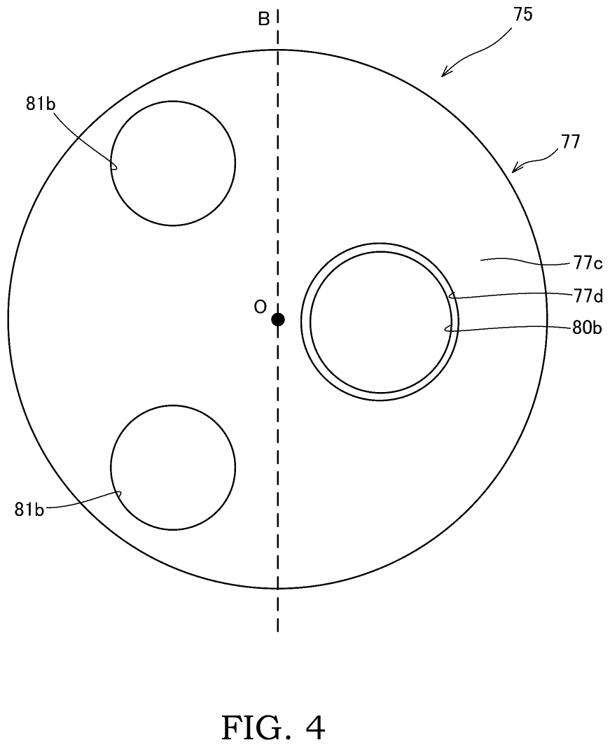

As shown in FIG. 4, in this embodiment, the pipe attachment hole 77d and an opening of the passage 80b of the first passage 80 are provided so as to be offset from the center axis O of the rod member 60. In other words, the end portion of the pipe 65 that is attached to the pipe attachment hole 77d and the passage 80b are provided such that their centers are offset from the center axis O of the rod member 60. As described above, the first rod inner passage 63 and the pipe 65 are provided by being gently inclined in the rod member 60 such that their first ends coincide with the center axis O of the rod member 60 and their second ends are offset from the center axis O of the rod member 60. In FIG. 4, the offset of the pipe attachment hole 77d and the opening of the passage 80b from the center axis O is shown in an exaggerated manner. The pipe attachment hole 77d and the opening of the passage 80b of the first passage 80 may be provided so as to coincide with the center axis O of the rod member 60.

As shown in FIGS. 3 and 4, the second passage 81 opens at the tip end surface 78c of the projecting portion 78 and at the end surface 77c of the connecting portion 77. On the tip end surface 78c of the projecting portion 78, the second passage 81 opens closer to the attachment portion 76 relative to the first passage 80. The second passage 81 has a main passage 81a that opens at the outer surface of the rod head 75 and a plurality of branch passages 81b that are provided so as to be branched from an end portion of the main passage 81a and that each communicates with the second rod inner passage 64. In this embodiment, two branch passages 81b are provided. Specifically, the main passage 81a is provided so as to extend linearly from the tip end surface 78c of the projecting portion 78. The branch passages 81b are provided so as to be branched from the main passage 81a in the vertical direction of the rod head 75 (in the direction perpendicular to the plane of the drawing in FIG. 2) and so as to extend linearly in parallel with each other to the end surface 77c of the connecting portion 77. The branch passages 81b are provided so as not to communicate with the passage 80a of the first passage 80 and so as to cross with the passage 80a in the plan views shown in FIGS. 1 and 2. In other words, the passage 80a of the first passage 80 is provided so as to cross between the two branch passages 81b, and the passage 80a of the first passage 80 is positioned between the two branch passages 81b. The main passage 81a and the branch passages 81b are provided so as to each has a uniform flow path cross-sectional area. In addition, the flow path cross-sectional area of the main passage 81a is set so as to be equal to or larger than the total of the flow path cross-sectional areas of the two branch passages 81b. Note that two or more branch passages 81b may be provided.

As shown in FIG. 4, the opening of the passage 80b to the first rod inner passage 63 and two openings of the branch passages 81b to the second rod inner passage 64 are provided such that the shape formed by connecting respective centers becomes a triangular shape. Specifically, when the end surface 77c is divided into two semicircles by an imaginary line B through the center axis O of the rod member 60, the center of the opening of the passage 80b is located in one of the semicircles (in the semicircle on the right side in FIG. 4), and the centers of the two openings of the branch passages 81b are located in the other of the semicircles (in the semicircle on the left side in FIG. 4).

In the hydraulic cylinder, when the flow path cross-sectional area of a flow path for guiding the working oil is small, a pressure loss caused in the flow path becomes large. If, in the hydraulic cylinders such as those described in this embodiment, a plurality of branch passages are not provided in the second passage and the second passage is a single passage having no branch, in order to increase the flow path cross-sectional area of the second passage, it is conceivable to increase the diameter of the second passage. However, the diameter of the second passage cannot be increased so as to be larger than the second rod inner passage to which it is communicated. Especially, because the second rod inner passage has an annular shape, it is difficult to increase the diameter of the second passage. If the diameter of the second passage is increased by increasing the diameter of the second rod inner passage, the diameter of the rod member is increased, and as a result, the size of the hydraulic cylinder is increased.

In contrast, in the hydraulic cylinder 100 of this embodiment, by configuring parts of the second passage 81 with the plurality of branch passages 81b, it is possible to increase the total of the flow path cross-sectional areas of the parts of the second passage 81. In other words, it is possible to increase the total of the flow path cross-sectional areas of the plurality of branch passages 81b without increasing the diameter of the second rod inner passage 64. In addition, the main passage 81a of the second passage 81 does not communicate with the second rod inner passage 64 directly. Therefore, it is possible to increase the flow path cross-sectional area of the main passage 81a by increasing the diameter of the main passage 81a without increasing the diameter of the second rod inner passage 64. Thus, it is possible to reduce the pressure loss caused in the second passage 81 without increasing the size of the hydraulic cylinder 100.

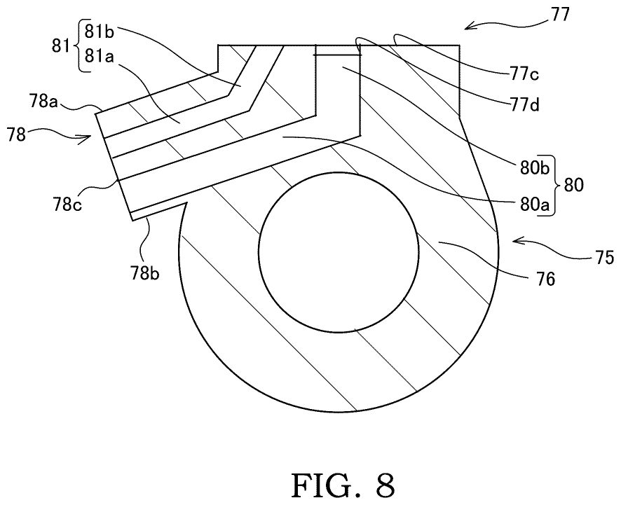

In addition, in the hydraulic cylinder 100 of this embodiment, on the tip end surface 78c of the projecting portion 78, the second passage 81 opens closer to the attachment portion 76 relative to the first passage 80, and the first passage 80 is provided so as to cross between the plurality of branch passages 81b of the second passage 81. Therefore, it is possible to make the first passage 80 (specifically, the passage 80b of the first passage 80) shorter compared with a configuration in which the first passage 80 is provided so as not to cross between the plurality of branch passages 81b of the second passage 81 as in a second modification shown in FIG. 8, which will be described later. Thus, it is possible to make the rod head 75 more compact.

Next, the operation of the hydraulic cylinder 100 will be described with reference to FIGS. 1, and 5 to 7. In the following, a description will be given of a case in which the hydraulic cylinder 100 is attached to the target object such that the cylinder-side attachment portion 70 is positioned on the vertically upper side and the rod head 75 is positioned on the vertically lower side.

When the hydraulic cylinder 100 is being extended, the working oil is supplied from a hydraulic pressure source (not shown), such as the pump, etc., to the counter rod side chamber 5 through the first passage 80, and the working oil in the first, second, and third rod side chambers 2, 3, and 4 is discharged to a the tank (not shown) through the second passage 81. When the hydraulic cylinder 100 is being extended, the first piston 30, the second piston 40, and the third piston 50 are moved relative to the cylinder tube 10 in this order.

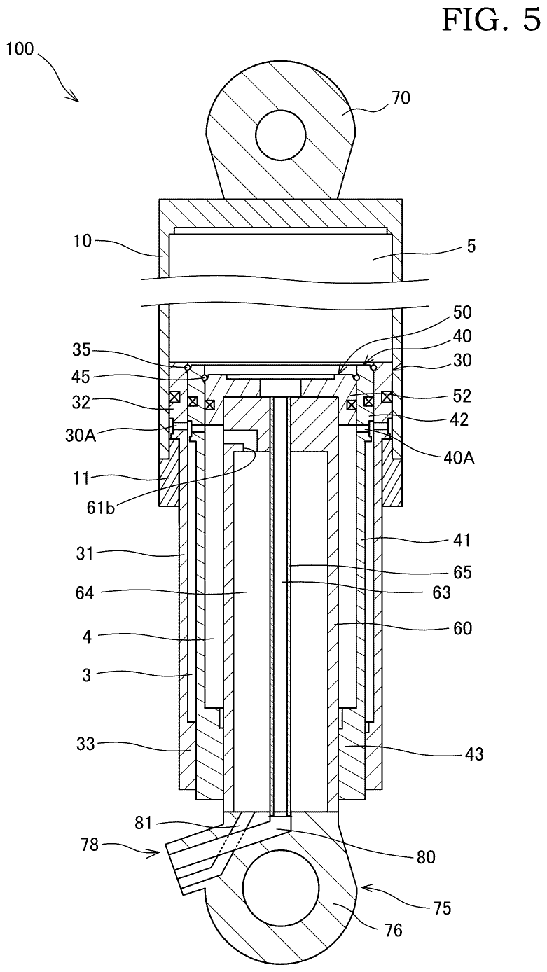

When the hydraulic cylinder 100 is being extended from the most-contracted state shown in FIG. 1, the working oil is supplied to the counter rod side chamber 5 through the first passage 80. Here, the pressure receiving areas for receiving the pressure in the counter rod side chamber 5 are each formed to be the largest for the first piston 30 and the smallest for the third piston 50. In other words, the inner pistons have a smaller pressure receiving area. Thus, when the hydraulic cylinder 100 is being extended from the most-contracted state, the cylinder tube 10 is first moved relative to the first piston 30. Specifically, as shown in FIG. 5, the cylinder tube 10 is moved upward relative to the first piston 30 (upward in FIG. 5).

By the relative movement between the first piston 30 and the cylinder tube 10, the working oil in the first rod side chamber 2 is discharged by being guided to the second passage 81 through the first communication port 30A, the second rod side chamber 3, the second communication port 40A, the third rod side chamber 4, the second through hole 61b, and the second rod inner passage 64.

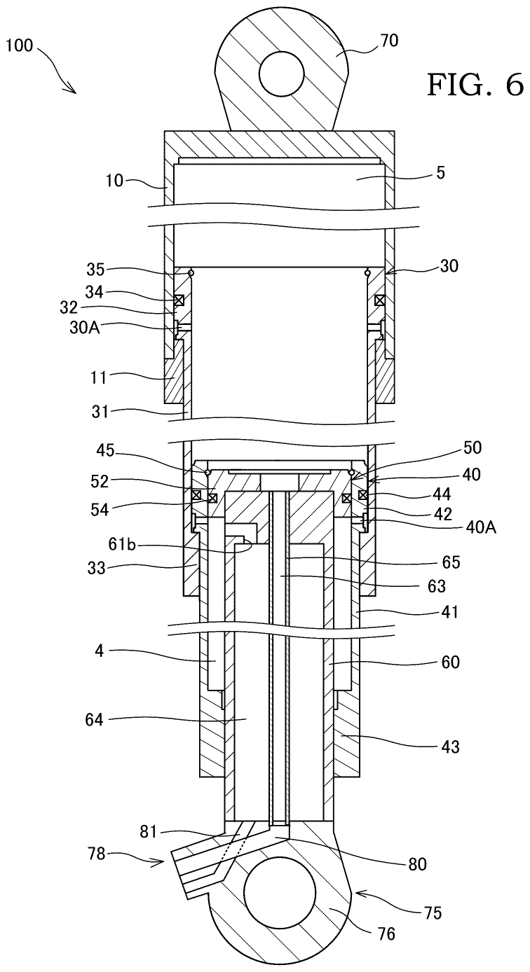

As shown in FIG. 5, when the cylinder tube 10 is moved to the extension stroke end of the first piston 30 where the cylinder head 11 comes into contact with the first piston 30, the cylinder tube 10 and the first piston 30 are moved relative to the second piston 40 having the larger pressure receiving area than the third piston 50 due to the pressure in the counter rod side chamber 5. Specifically, as shown in FIG. 6, the cylinder tube 10 and the first piston 30 are moved upward relative to the second piston 40 (upward in FIG. 6).

By the relative movement between the first piston 30 and the second piston 40, the working oil in the second rod side chamber 3 is discharged by being guided to the second passage 81 through the second communication port 40A, the third rod side chamber 4, the second through hole 61b, and the second rod inner passage 64.

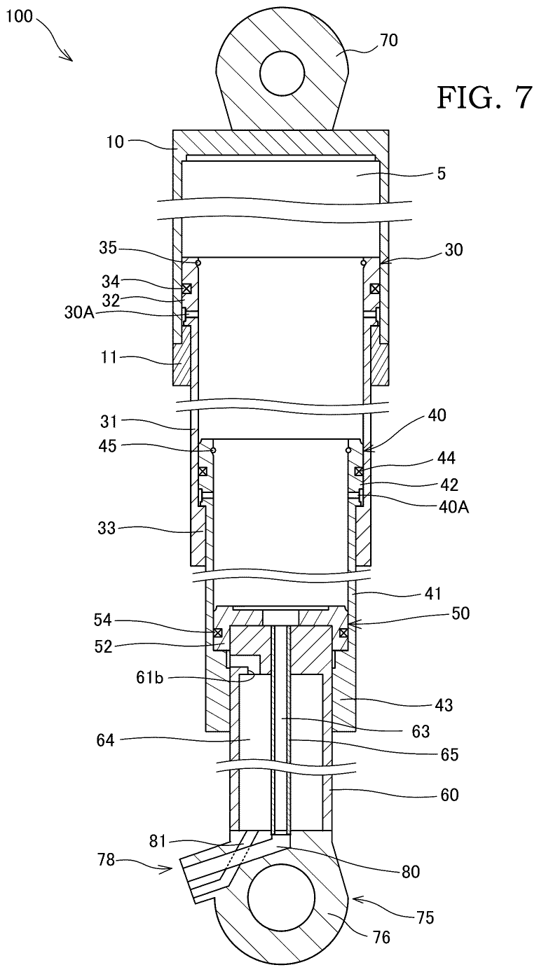

As shown in FIG. 6, when the cylinder tube 10 and the first piston 30 are moved to the extension stroke end of the second piston 40 where the first support portion 33 of the first piston 30 comes into contact with the second piston 40, the cylinder tube 10, the first piston 30, and the second piston 40 are moved relative to the third piston 50 by receiving the pressure in the counter rod side chamber 5. Specifically, as shown in FIG. 7, the cylinder tube 10, the first piston 30, and the second piston 40 are moved upward relative to the third piston 50 (upward in FIG. 7).

By the relative movement between the third piston 50 and the second piston 40, the working oil in the third rod side chamber 4 is discharged by being guided to the second passage 81 through the second through hole 61b, and the second rod inner passage 64. The cylinder tube 10, the first piston 30, and the second piston 40 are moved until the second support portion 43 of the second piston 40 comes into contact with the third piston 50. As described above, as shown in FIG. 7, the hydraulic cylinder 100 becomes the most-extended state.

When the hydraulic cylinder 100 is being contracted, the working oil is supplied from the hydraulic pressure source to the first, second, and third rod side chambers 2, 3, and 4 through the second passage 81, the second rod inner passage 64, and the second through hole 61b, and the working oil in the counter rod side chamber 5 is discharged to the tank through the first rod inner passage 63 and the first passage 80. When the hydraulic cylinder 100 is being contracted, the third piston 50, the second piston 40, and the first piston 30 are moved relative to the cylinder tube 10 in this order. Alternatively, the hydraulic cylinder 100 is contracted by the weight of a target device to be driven connected to the cylinder tube 10 and the cylinder-side attachment portion 70. In such a case, there is no need to supply the working oil to the first, second, and third rod side chambers 2, 3, and 4.

According to this embodiment described above, following effects can be afforded.

In the hydraulic cylinder 100, the working oil is guided to the second rod inner passage 64 through each of the plurality of branch passages 81b of the second passage 81. By configuring the parts of the second passage 81 with the plurality of branch passages 81b, it is possible to increase the flow path cross-sectional area of the second passage 81 without increasing the diameter of the second rod inner passage 64. Thus, it is possible to reduce the pressure loss caused in the second passage 81 without increasing the size of the hydraulic cylinder 100.

In the hydraulic cylinder 100, the second passage 81 opens closer to the attachment portion 76 relative to the first passage 80, and the first passage 80 is provided so as to cross between the plurality of branch passages 81b of the second passage 81, and therefore, it is possible to make the first passage 80 shorter. Thus, it is possible to make the rod head 75 more compact.

Next, modifications of this embodiment will be described.

### First Modification

In the above-mentioned embodiment, the first rod inner passage 63 communicates with the counter rod side chamber 5, and the second rod inner passage 64 communicates with the rod side chamber 1. The configuration is not limited thereto, and the hydraulic cylinder 100 may also have a configuration in which the first rod inner passage 63 communicates with the rod side chamber 1, and the second rod inner passage 64 communicates with the counter rod side chamber 5. Specifically, the first rod inner passage 63 may communicate with the third rod side chamber 4 by being formed so as to be bent in the radial direction in the rod member 60, and the second rod inner passage 64 may communicate with the counter rod side chamber 5 by being formed so as to penetrate through the bottom portion 61 of the rod member 60 in the axial direction. With such a configuration, the similar effects as those of the above-mentioned embodiment can be afforded.

### Second Modification

In the above-mentioned embodiment, in the plan views shown in FIGS. 1 and 2, the branch passages 81b of the second passage 81 are provided so as to cross the passage 80a of the first passage 80. The configuration is not limited thereto, and in the hydraulic cylinder 100, the second passage 81 may be provided so as not to cross the first passage 80 in the plan views shown in FIGS. 1 and 2. Specifically, as shown in FIG. 8, the second passage 81 may open closer to the rod-side inclined side surface 78a relative to the first passage 80 at the tip end surface 78c of the projecting portion 78, and the branch passages 81b may be provided so as not to cross the passage 80a of the first passage 80 in the plan view shown in FIG. 8.

In the above-mentioned embodiment, in the plan views shown in FIGS. 1 and 2, the branch passages 81b cross the passage 80a, and the passage 80a is positioned between the two branch passages 81b. Therefore, even if the diameters of the branch passages 81b are to be increased without increasing the diameter of the second rod inner passage 64, the distance between the two branch passages 81b needs to be greater than the passage 80b, and so, there is limitation in increasing the diameters of the branch passages 81b. In contrast, in this modification, the passage 80a of the first passage 80 is not positioned between the two branch passages 81b. In other words, the passage 80a is provided by extending so as not be positioned between the plurality of branch passages 81b. Therefore, it is possible to increase the total of the flow path cross-sectional areas of the branch passages 81b by increasing the diameters of the branch passages 81b without increasing the diameter of the second rod inner passage 64.

Furthermore, as shown in FIG. 4, in the above-mentioned embodiment, the end portion of the pipe 65 and the passage 80b of the first passage 80 are provided such that their centers are offset from the center axis O of the rod member 60. With such a configuration, it is possible to ensure the maximum opening areas to the two branch passages 81b to the second rod inner passage 64 within a limited space. Therefore, by employing the configuration in which the passage 80a of the first passage 80 is not positioned between the two branch passages 81b as in this modification, it is possible to further increase the total of the flow path cross-sectional areas of the branch passages 81b by further increasing the diameters of the branch passages 81b.

### Third Modification

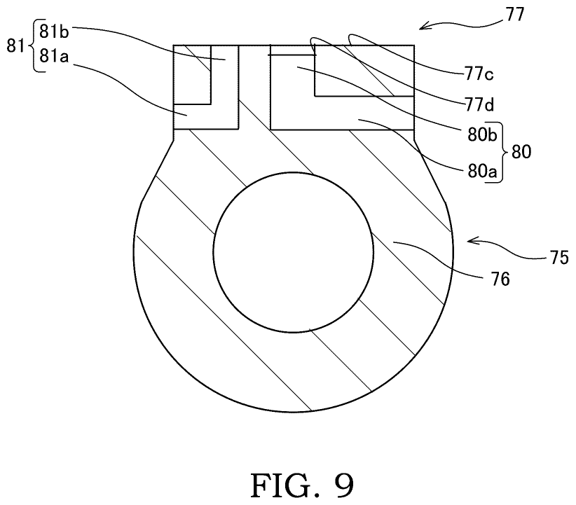

In the above-mentioned embodiment, the rod head 75 has the projecting portion 78, and the first passage 80 and the second passage 81 opens at the tip end surface 78c of the projecting portion 78. The configuration is not limited thereto, and as shown in FIG. 9, the rod head 75 may not have the projecting portion 78, and the first passage 80 and the second passage 81 may be provided so as to open at a side surface of the connecting portion 77. The passage 80a of the first passage 80 and the main passage 81a of the second passage 81 may open so as to be separated away from each other by 180 degrees. Also with such a configuration, similarly to the above-described second modification, it is possible to increase the diameters of the branch passages 81b without increasing the diameter of the second rod inner passage 64. Furthermore, as shown in FIG. 4, it is possible to ensure the maximum opening areas to the two branch passages 81b to the second rod inner passage 64 within a limited space by providing the passage 80b of the first passage 80 such that its center is offset from the center axis O of the rod member 60.

### Fourth Modification

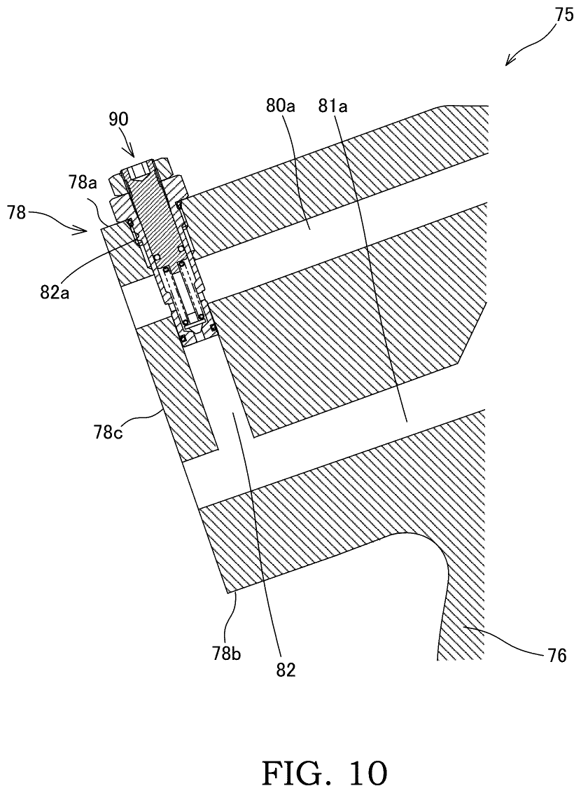

In the above-mentioned embodiment, the rod head 75 has the first passage 80 through which the outside of the rod head 75 and the first rod inner passage 63 are communicated and the second passage 81 through which the outside of the rod head 75 and the second rod inner passage 64 are communicated. In addition, as shown in FIG. 10, the rod head 75 may have a third passage 82 through which the first passage 80 and the second passage 81 can be communicated and a relief valve 90 that is provided in the third passage 82. The third passage 82 opens at the rod-side inclined side surface 78a of the projecting portion 78, and the relief valve 90 is provided in the third passage 82 by being inserted from the opening. The relief valve 90 is opened when the pressure in the second passage 81 becomes higher than the pressure in the first passage 80 by a predetermined value or more, thereby allowing the flow of the working oil from the second passage 81 to the first passage 80. As described above, in this modification, the third passage 82 and the relief valve 90 are provided in the projecting portion 78.

The hydraulic cylinder may experience an external force that forces the hydraulic cylinder to extend beyond its extension speed during the extension. For example, with the hydraulic cylinder that is attached between the cargo bed of the dump truck and the vehicle body and that is extended to tilt the cargo bed and discharge the loaded material, when the loaded material is discharged at once, a force is exerted such that the cargo bed is caused to instantaneously rotate about a connecting portion with the vehicle body due to the weight of the loaded material immediately before discharge at the edge of the cargo bed. Thus, the hydraulic cylinder is subjected to the the external force that forces the hydraulic cylinder to extend beyond its extension speed during the extension. In this case, the supply of the working oil becomes insufficient and negative pressure is generated in the counter rod side chamber, and the discharge of the working oil becomes insufficient and the pressure is increased in the rod side chamber. In this state, when the external force acting on the hydraulic cylinder is removed, the hydraulic cylinder is caused to be contracted instantaneously due to the negative pressure in the counter rod side chamber. As a result, there is a risk in that a shock is caused within the hydraulic cylinder.

In contrast, in the hydraulic cylinder 100 of this modification, the third passage 82 and the relief valve 90 are provided in the rod head 75, and when the pressure in the second passage 81 becomes higher than the pressure in the first passage 80 by a predetermined value or more, the relief valve 90 allows the flow of the working oil from the second passage 81 to the first passage 80. Thus, by adjusting a relief pressure of the relief valve 90, it is possible to guide the working oil from the rod side chamber 1 to the counter rod side chamber 5 through the third passage 82 when the external force that forces the hydraulic cylinder 100 to extend beyond the extension speed during the extension of the hydraulic cylinder 100 is exerted. Thus, the occurrence of the shock caused by the instantaneous contraction of the hydraulic cylinder 100 is prevented. Furthermore, in the hydraulic cylinder 100, because the third passage 82 and the relief valve 90 are provided in the rod head 75 close to the rod side chamber 1 and the counter rod side chamber 5, it is possible to effectively prevent the counter rod side chamber 5 from becoming the negative pressure.

In addition, in the hydraulic cylinder 100 of this modification, because the third passage 82 opens at the rod-side inclined side surface 78a of the projecting portion 78, and the relief valve 90 is provided by being inserted into the opening, it is possible to perform attachment, adjustment, and replacement of the relief valve 90 with ease. Furthermore, the relief valve 90 is provided in the rod-side inclined side surface 78a of the projecting portion 78 that is continuous with the outer circumferential surface of the rod member 60. In the projecting portion 78, the rod-side inclined side surface 78a is formed to have a longer dimension in the projecting direction than the rod-head-side inclined side surface 78b. Therefore, by providing the relief valve 90 in the rod-side inclined side surface 78a, a space for providing the relief valve 90 can be secured even if the projected amount of the projecting portion 78 from the attachment portion 76 is small, and so, it is possible to make the hydraulic cylinder 100 compact.

The configurations, operations, and effects of the embodiment of the present invention will be collectively described below.

The hydraulic cylinder 100 includes: the cylinder tube 10; the piston unit 20 slidably inserted into the cylinder tube 10, the piston unit 20 being configured to define the rod side chamber 1 and the counter rod side chamber 5 inside the cylinder tube 10; the rod member 60 inserted into the cylinder tube 10, the first end of the rod member 60 being connected to the piston unit 20; and the rod head 75 provided on the second end of the rod member 60, wherein the rod member 60 has: the first rod inner passage 63 provided inside the rod member 60, the first rod inner passage 63 being configured to guide the hydraulic fluid to one of the rod side chamber 1 and the counter rod side chamber 5; and the annular second rod inner passage 64 provided inside the rod member 60 so as to surround the first rod inner passage 63, the second rod inner passage 64 being configured to guide the hydraulic fluid to the other of the rod side chamber 1 and the counter rod side chamber 5, the rod head 75 has: the first passage 80 through which the outside of the rod head 75 and the first rod inner passage 63 are communicated; and the second passage 81 through which the outside of the rod head 75 and the second rod inner passage 64 are communicated, and the second passage 81 has: the main passage 81a opening at the outer surface of the rod head 75; and the plurality of branch passages 81b provided by being branched from the main passage 81a, the branch passages 81b each communicating with the second rod inner passage 64.

With this configuration, the annular second rod inner passage 64 is provided inside the rod member 60 so as to surround the first rod inner passage 63, and the plurality of branch passages 81b of the second passage 81 each guides the hydraulic fluid to the second rod inner passage 64. As described above, by configuring the parts of the second passage 81 with the plurality of branch passages 81b, it is possible to increase the flow path cross-sectional area of the second passage 81 without increasing the diameter of the second rod inner passage 64. Thus, it is possible to reduce the pressure loss caused in the second passage 81.

In addition, in the hydraulic cylinder 100, the first passage 80 is provided by extending so as not be positioned between the plurality of branch passages 81b.

With this configuration, the first passage 80 is not positioned between the plurality of branch passages 81b. Therefore, it is possible to increase the total of the flow path cross-sectional areas of the branch passages 81b by increasing the diameters of the branch passages 81b without increasing the diameter of the second rod inner passage 64.

In addition, in the hydraulic cylinder 100, the first rod inner passage 63 is provided such that a communicating portion with the first passage 80 is offset from the center of the rod member 60.

With this configuration, because the first rod inner passage 63 is provided so as to be offset from the center axis of the rod member 60, it is possible to ensure the maximum areas where the plurality of branch passages 81b of the second passage 81 communicate with the second rod inner passage 64.

In addition, in the hydraulic cylinder 100, the rod head 75 further has: the cylindrical attachment portion 76 to be attached to the attachment target; and the projecting portion 78 projecting from the outer surface of the attachment portion 76, the first passage 80 and the second passage 81 are provided so as each has the opening at the tip end surface 78c of the projecting portion 78 in the projecting direction, the opening of the second passage 81 is provided so as to be closer to the attachment portion 76 relative to the opening of the first passage 80, and the first passage 80 is provided so as to cross between the plurality of branch passages 81b.

With this configuration, the second passage 81 opens closer to the attachment portion 76 relative to the first passage 80, and the first passage 80 is provided so as to cross between the plurality of branch passages 81b of the second passage 81, and so, it is possible to make the first passage 80 shorter. Thus, it is possible to make the rod head 75 compact.

Embodiments of the present invention were described above, but the above embodiments are merely examples of applications of the present invention, and the technical scope of the present invention is not limited to the specific constitutions of the above embodiments.

In this embodiment, although a multistage fluid pressure cylinder has been described as an example, the present invention can also be applied to the fluid pressure cylinder other than the multistage fluid pressure cylinder as long as the fluid pressure cylinder is provided with, in the rod member, the rod inner passage for guiding the hydraulic fluid to the rod side chamber and the counter rod side chamber.

With respect to the above description, the contents of application No. 2022-44047, with a filing date of Mar. 18, 2022 in Japan, are incorporated herein by reference.

1. A fluid pressure cylinder comprising:
a cylinder tube;
a piston unit slidably inserted into the cylinder tube, the piston unit being configured to define a rod side chamber and a counter rod side chamber inside the cylinder tube;
a rod member inserted into the cylinder tube, a first end of the rod member being connected to the piston unit; and
a rod head provided on a second end of the rod member, wherein
the rod member has:
a first rod inner passage provided inside the rod member, the first rod inner passage being configured to guide hydraulic fluid to one of the rod side chamber and the counter rod side chamber; and
an annular second rod inner passage provided inside the rod member so as to surround the first rod inner passage, the second rod inner passage being configured to guide hydraulic fluid to other of the rod side chamber and the counter rod side chamber, the rod head has:
a first passage through which outside of the rod head and the first rod inner passage are communicated; and
a second passage through which the outside of the rod head and the second rod inner passage are communicated, and
the second passage has:
a main passage opening at an outer surface of the rod head; and
a plurality of branch passages provided by being branched from the main passage, the branch passages each communicating with the second rod inner passage.

2. The fluid pressure cylinder according to claim 1, wherein
the first passage is provided by extending so as not be positioned between the plurality of branch passages.

3. The fluid pressure cylinder according to claim 2, wherein
the first rod inner passage is provided such that a communicating portion with the first passage is offset from a center of the rod member.

4. The fluid pressure cylinder according to claim 1, wherein
the rod head further has:
a cylindrical attachment portion to be attached to an attachment target; and
a projecting portion projecting from an outer surface of the attachment portion,
the first passage and the second passage are provided so as to each have an opening at a tip end surface of the projecting portion in a projecting direction,
the opening of the second passage is provided so as to be closer to the attachment portion relative to the opening of the first passage, and
the first passage is provided so as to cross between the plurality of branch passages.

5. The fluid pressure cylinder according to claim 1, wherein
the rod head further has:
a third passage through which the first passage and the second passage can be communicated; and
a relief valve provided in the third passage, the relief valve being configured to allow flow of the hydraulic fluid from the second passage to the first passage when a pressure in the second passage becomes higher than a pressure in the first passage by a predetermined value or more.

6. The fluid pressure cylinder according to claim 5, wherein
the third passage is provided to have an opening at an outer surface of the rod head, and
the relief valve is provided in the third passage by being inserted into the opening.

7. The fluid pressure cylinder according to claim 6, wherein
the rod head further has:
a cylindrical attachment portion to be attached to an attachment target; and
a projecting portion projecting from an outer surface of the attachment portion, the first passage and the second passage are provided so as to each have an opening at an outer surface of the projecting portion, and
the third passage and the relief valve are provided in the projecting portion.

8. The fluid pressure cylinder according to claim 7, wherein
the projecting portion has an inclined side surface, the inclined side surface being formed so as to be continuous with an outer circumferential surface of the rod member and so as to be inclined towards the attachment portion side,
the opening of the first passage and the opening of the second passage are provided at a tip end surface of the projecting portion in a projecting direction,
the opening of the second passage is provided so as to be closer to the attachment portion relative to the opening of the first passage, and
the opening of the third passage is provided at the inclined side surface of the projecting portion.
